(19) United States
(12) Patent Application Publication
(10) Pub. No.: US 2026/0115848 A1
(43) Pub. Date: Apr. 30, 2026

(54) Machine Tool Fixture

(71) Applicant: Teknovisestop LLC, North Salt Lake, UT (US)

(72) Inventor: Kevin J. Tumia, North Salt Lake, UT (US)

(21) Appl. No.: 18/933,834

(22) Filed: Oct. 31, 2024

(51) Int. Cl. B23Q 3/06

(52) U.S. Cl. CPC B23Q 3/066

(57) ABSTRACT

A machine tool fixture to aid in positioning a part to be machined within a vise includes a vise block attachable to the vise, and a primary takeoff movably couplable to the vise block. A primary rod extends from the primary takeoff, and a receiving bore is formed in the vise block. A set screw bore intersects the receiving bore. A set screw is receivable within the set screw bore and bears upon a locking disk positioned between the primary rod and the set screw. The locking disk has a set screw contact surface and a rod contact surface, a contour of the rod contact surface matching a contour of a portion of an outer surface of the primary rod. A locating armature is configured to contact a part to be machined on the machining table to properly position the part relative to the machining table.

### BACKGROUND OF THE INVENTION

### Field of the Invention

The present invention relates generally to fixtures used in machine tool shops to precisely locate workpieces for precision machining.

### Description of Related Art

Machine tool shops employ specialized technicians trained to use multi-axis machines, including computer numerical controlled (CNC) machines, to form custom shaped, three-dimensional parts from a variety of bulk materials such as metals or plastics. The terms “CNC machine,” “multi-axis machine,” and “machine tool” can be used herein synonymously to describe a power tool or machine that operates on a workpiece using a vise, fixture or jig. Technicians may employ specialized fixtures or jigs to secure a workpiece relative to the machining bit of such a machine. A fixture can be an adjustable device that attaches to the bed of a CNC machine, or a vise attached to the bed of the CNC machine, that allows precision and repeatability of placement and support of a workpiece upon which the CNC machine will perform some operation, e.g., drilling, milling, etc.

Conventional fixtures come in a variety of forms and may be classified according to the type of machine tool for which they are designed to cooperate with. Milling operations tend to involve large, straight cuts that produce lots of chips and involve varying force. Locating and supporting areas of a milling fixture must usually be large and very sturdy in order to accommodate milling operations. Strong clamps are also generally required. Because of the significant amount of vibration of a milling machine, positive stops are generally preferred over friction for securing the workpiece. For high-volume automated processes, milling fixtures usually involve hydraulic or pneumatic clamps. Conventional fixtures, when sufficiently strong to withstand these forces, have proven overly bulky and difficult to adjust with precision.

Accordingly, there remains a need in the art for a fixture that can provide precision adjustments while also providing sufficient strength to withstand the stresses of the machining process.

### SUMMARY OF THE INVENTION

In accordance with one aspect of the technology, a machine tool fixture is provided to aid in positioning a part to be machined within a vise, the machine tool fixture includes a vise block, attachable to a vise suitable for mounting on a machining table. A primary takeoff can be movably couplable to the vise block. One of the primary takeoff and the vise block can have: i) a primary rod extending therefrom, ii) a block receiving bore formed therein, the primary rod being moveably receivable within the block receiving bore, and iii) a block set screw bore intersecting the block receiving bore. A block set screw can be receivable within the block set screw bore. A block locking disk can be receivable in the block set screw bore between the primary rod and the block set screw, the block locking disk having a set screw contact surface and a rod contact surface, a contour of the rod contact surface matching a contour of a portion of an outer surface of the primary rod. The block locking disk can be sized and shaped to enable a force applied by the block set screw to the set screw contact surface to be transferred through the block locking disk to the rod contact surface and distribute the force evenly across the rod contact surface to the portion of the outer surface of the primary rod. A locating armature can be carried by the machine tool fixture, the locating armature having a contact surface configured to contact a part to be machined on the machining table to properly position the part relative to the machining table.

In accordance with another aspect of the technology, a secondary takeoff can be movably coupleable to the primary takeoff, the secondary takeoff including a secondary rod movably receivable within a primary receiving bore of the primary takeoff, and a primary set screw bore is formed in the primary takeoff intersecting the primary receiving bore, and a primary locking disk is receivable in the primary set screw bore of the primary takeoff between a primary set screw and the secondary rod.

In accordance with another aspect of the technology, a locating armature can be carried by the machine tool fixture, the locating armature having a contact surface configured to contact a part to be machined on the machining table to properly position the part relative to the machining table. An armature rod can be moveably coupled to the secondary takeoff, the armature rod movably receiving the locating armature therein. The armature rod can include a pair of armature bores formed therein, the armature bores having differing diameters. An armature rod cap can be fittable over a portion of the armature rod, the armature rod cap having a pair of cap bores formed therethrough having differing diameters, and wherein the locating armature is movably receivable through one of the cap bores and one of the armature bores.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of a machining vise for installation upon a machining table, the vise having a machine tool fixture in accordance with the present technology installed thereon;

FIG. 2 is a perspective view of the machine tool fixture showed in FIG. 1;

FIG. 3 is an exploded, perspective of the machine tool fixture of FIG. 1;

FIG. 4A is a side view of a vise block having a primary takeoff installed therein in accordance with an embodiment of the technology;

FIG. 4B is a partially exploded view of the vise block of FIG. 4A;

FIG. 5A is an end view of the primary takeoff of FIG. 4A, with a primary locking disk positioned thereon;

FIG. 5B is an end view of the primary takeoff of FIG. 4A, with the primary locking disk shown partially removed from position on the primary rod;

FIG. 6 is a sectional view of the primary locking disk of FIG. 5B;

FIG. 7A is an end view of an armature rod in accordance with an embodiment of the technology;

FIG. 7B is a side view of the armature rod of FIG. 7A;

FIG. 7C is a side view of the armature rod of FIG. 7A, shown rotated 90 degrees relative to the view in FIG. 7B;

FIG. 8A is an end view of an armature rod cap in accordance with an embodiment of the technology; and

FIG. 8B is a side, sectioned view of the armature cap of FIG. 8A, taken along section A-A of FIG. 8A.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

### Definitions

As used herein, the singular forms “a” and “the” can include plural referents unless the context clearly dictates otherwise. Thus, for example, reference to “a rod” can include one or more of such rods, if the context dictates.

The term “set screw” is used herein to describe a variety of manners by which one part can be secured in position relative to another part. While such term can include the commonly known threaded screw, it can also include other types of fittings, so long as such fittings apply sufficient force to lock two components in position relative to one another.

As used herein, the term “substantially” refers to the complete or nearly complete extent or degree of an action, characteristic, property, state, structure, item, or result. As an arbitrary example, an object that is “substantially” enclosed is an article that is either completely enclosed or nearly completely enclosed. The exact allowable degree of deviation from absolute completeness may in some cases depend upon the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. As another arbitrary example, a composition that is “substantially free of” an ingredient or element may still actually contain such item so long as there is no measurable effect as a result thereof.

As used herein, the term “about” is used to provide flexibility to a numerical range endpoint by providing that a given value may be “a little above” or “a little below” the endpoint.

Relative directional terms can sometimes be used herein to describe and claim various components of the present invention. Such terms include, without limitation, “upward,” “downward,” “horizontal,” “vertical,” etc. These terms are generally not intended to be limiting, but are used to most clearly describe and claim the various features of the invention. Where such terms must carry some limitation, they are intended to be limited to usage commonly known and understood by those of ordinary skill in the art in the context of this disclosure. Generally, directional terms used in this application, such as “top” or “bottom” refer to the installed state. The formulations “substantially vertical” and “substantially horizontal” are to be construed such that the main extension direction is vertical and horizontal, respectively.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

### Invention

The present technology relates generally to a machine tool fixture that aids in precisely positioning a part to be machined within a vise fittable on a machining table. While not so limited, the current technology is particularly useful for locating and securing workpieces that are machined on a CNC multi-axis machine. The fixture can advantageously be used to allow quick, easy and repeated positioning of like-shaped parts in a vise to ensure that a multitude of such parts can be machined in repeated manner. Thus, once one part has been positioned and machined, it can be quickly removed from the vise and the next part to be machined can be quickly installed in the vise in precisely the correct position.

The present technology is intuitive to use and provides a robust framework that will not easily deform or deflect in ordinary use, so as to provide a precise and repeatable positioning aid. The technology can be used time after time, in different configurations, without damaging or marring the component parts—this ensures that each setup can be performed precisely, without damaged components of the fixture or compromising the ability to precisely position the components.

Though only one machine tool fixture is shown and described herein, it will be readily apparent to one of ordinary skill in the art that multiple vises, each with a fixture accordingly to the technology herein, can be installed on a machining table.

Utilizing the fixtures of the present technology can ensure that all parts produced using the fixture will maintain conformity of finished dimensions and interchangeability. Using the current fixtures improves the economy of production by allowing smooth operation and quick transition from part to part. This can also reduce the requirement for skilled labor, or specialized technicians, by simplifying how workpieces are mounted to the bed of a CNC machine. The present fixtures increase conformity across a production run.

One problem that is common with conventional fixtures is that, when tightening a locked pin or rod, the surface of the pin or rod may be deformed or gouged under the pressure applied by a set screw. This is particularly true if the leading end of the set screw is designed with teeth or cutting surfaces specifically designed to dig into the surface of the pin or rod. While useful for locking pins or rods one time, such damage to the surface of the pin or rod may prevent subsequent readjustment or use of the rod and the support structure in which it is mounted. The present technology addresses these limitations in the prior art.

Referring now to the figures, in one embodiment of the technology, a machine tool fixture assembly 100 is provided. The fixture can aid in accurately and securely positioning within a vise (52) a part (not shown) to be machined. The vise 52 can be positionable upon, and securely fixed to, a machining table 50, as is known in the art. The current fixture can include a vise block 110, a primary takeoff 120, a secondary takeoff 130, an armature rod 140, an armature rod cap 150, a locating armature 160, and a series of locking disks 180a, 180b (FIGS. 3-6), etc.

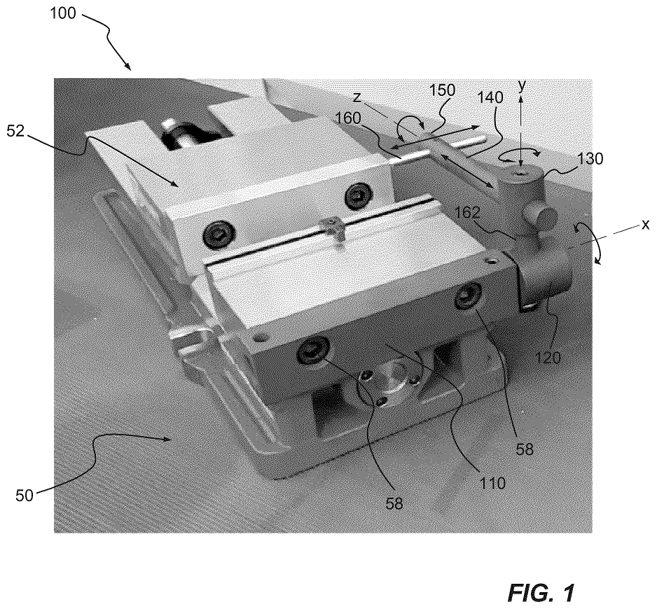

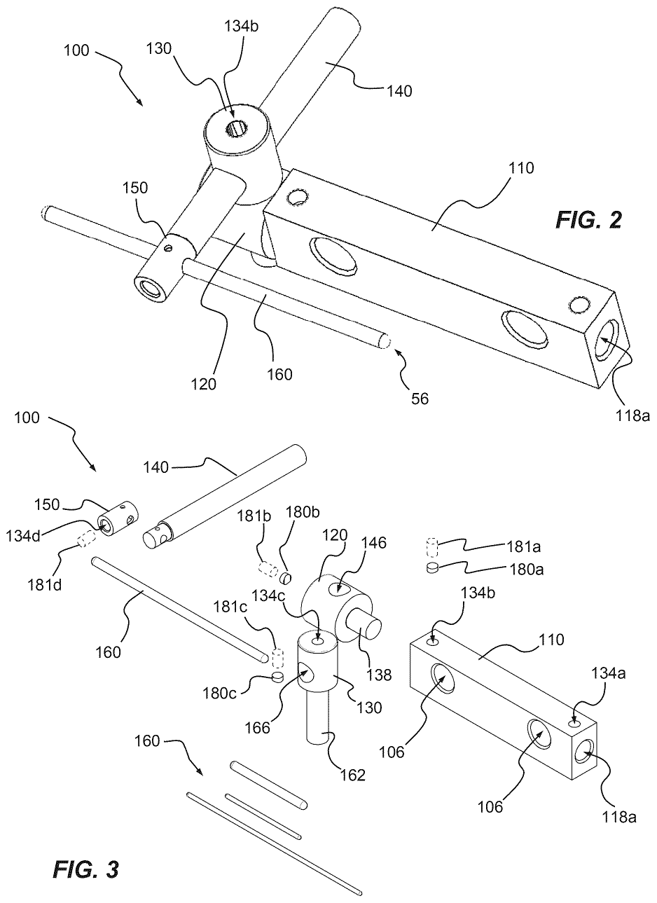

In one example, the vise block 110 can be formed from a brick-shaped block of metal, for example and not by way of limitation, formed of steel, aluminum, titanium, or other metal or metal alloy that is sufficiently durable for use in the machine tool industry. While not so required, the vise block can include two bore holes 106 (FIG. 3) which can be disposed symmetrically and perpendicularly through a front face and rear face of the block. As the purpose of the bore holes is to secure the block to the vise 52, the bore holes can be sized and shaped to receive therein mounting bolts (58 in FIG. 1) that are operable to mate with the vise being used.

The vise block 110 can further include symmetrical left and right faces which are generally parallel to one another, each including a block receiving bore 118a, 118b, respectively, disposed therein. Left and right block receiving bores can be, but are not necessarily, coaxial to each other. The vise block can further include top and bottom faces that are generally parallel to one another. As shown in the various figures, the top face can further include set screw bores 134a, 134b, that pass from the top face and into, or intersect with, the block receiving bores 118a, 118b, respectively. The set screw bores 134 can be threaded (not shown in detail) to accept therein threaded set screws 181a, 181b, etc., which can be positioned above a locking disk, as discussed in further detail below.

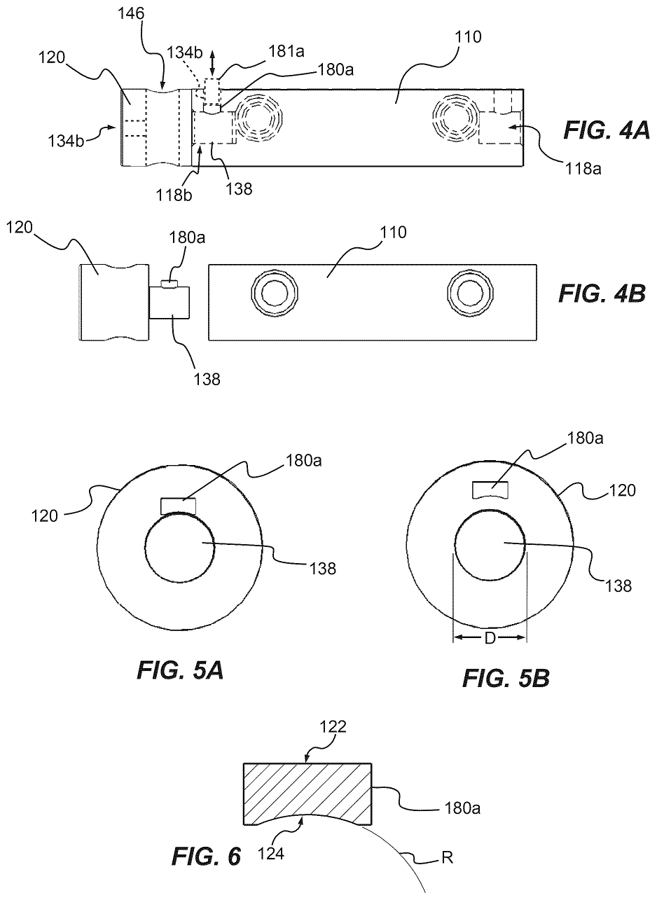

The primary takeoff 120 can, in one embodiment, be formed of two generally cylindrical components, one of which is a primary rod 138. Primary rod 138, as discussed in more detail below, can be receivable in one of the block receiving bores 118. The larger portion of the primary takeoff shown in this example can include a primary receiving bore 146 formed therein that can, as discussed in more detail below, receive therein a secondary rod 162 of a secondary takeoff 130. The larger portion of the primary takeoff can also include a set screw bore 134b (FIG. 4A) that can extend into, or intersect, the primary receiving bore. As with other set screw bores discussed herein, the set screw bore can include internal threads to engage with set screw 181b, which can be positioned above a locking disk, as discussed in further detail below.

The primary takeoff 120 can be formed of various hard metals, such as carbon steel, stainless steel, titanium and any other hard and durable metal that can be shaped as shown in the figures and support the various structural loads discussed herein.

In one embodiment, the system can include a secondary takeoff 130 that can extend the system into further degrees of adjustability. The secondary takeoff can be similar in configuration to the primary takeoff 120, with the exception, in some embodiments, of differing dimensions. The secondary takeoff can include a secondary rod 162 movably receivable with the primary receiving bore 146 of the primary takeoff. A secondary receiving bore 166 can be formed in the secondary takeoff to receive, as discussed in more detail, an armature rod 140. A secondary set screw bore 134c can be formed in the secondary takeoff, and can extend into or intersect the secondary receiving bore. Set screw 181c and locking disk 180c can be positioned within the set screw bore.

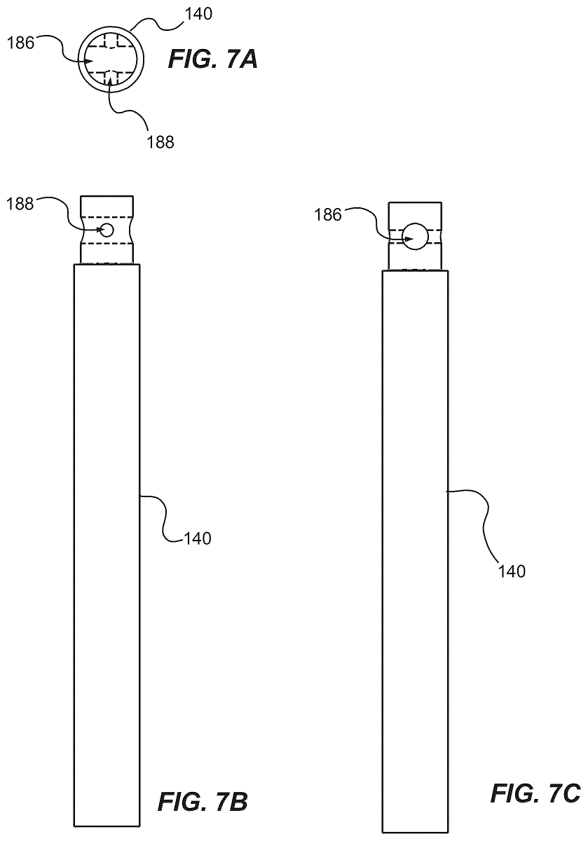

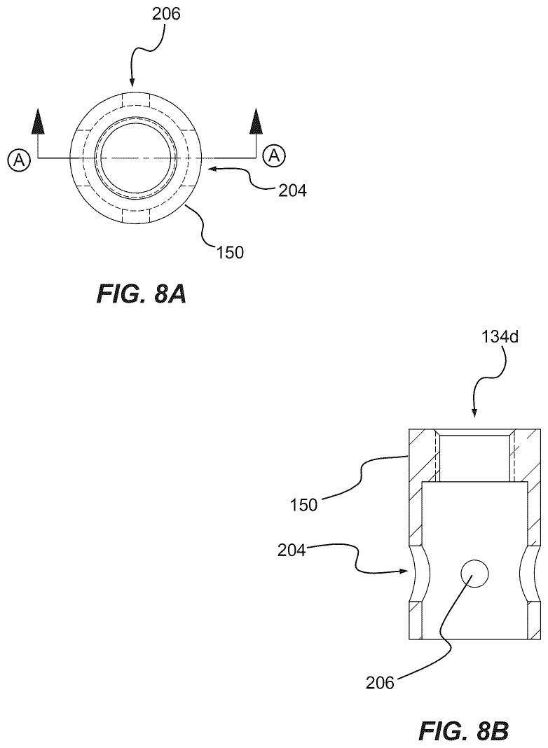

The system can also include an armature rod 140 that can be receivable in the secondary receiving bore 166. The armature rod can receive therein a locating armature 160. The locating armature can include a terminal portion, shown at 56 in FIG. 1, that can be hemispherical in shape. As shown in more detail in FIGS. 7A through 8B, according to an embodiment of the present invention, the armature rod can include a pair 186, 188 of armature bores formed therein. The armature bores can have differing diameters and can, in one embodiment, be oriented 180-degrees offset from one another. That is, they can be oriented such that a 90-degree angle is formed between bores 186 and 188.

An armature rod cap 150 (FIGS. 8A and 8B) can be fittable over an end of the armature rod 140 and can similarly include two bores, 204 and 206 arranged similarly therein. As shown by example in FIG. 1, the locating armature 160 can be formed in a variety of diameters, in one example a diameter of about 0.25 inches, or about 0.125 inches. Depending upon the size (and therefore strength) of locating armature desired, either bores 186 and 204 can be used, or bores 188 and 206 can be used to receive a locating armature therein. The rod cap can also include a set screw bore 134d formed in an end thereof, that can receive set screw 181d. Once the locating armature is positioned within the desired set of bores, set screw 181d can be tightened through set screw bore 134d until secure contact is made with the end of the armature rod. This, in turn, cinches the cap against the armature rod and thereby locks it into position. Prior to locking the rod in position, the rod can be translational adjusted to any desired position.

The various locating armatures 160 can be formed of a hardened metal, for example and not by way of limitation, carbon steel, stainless steel, titanium or other suitable metal constructed to withstand repeated adjustment, movement and locking within vise rod 140.

The various components of the fixture 100 can be assembled and securely engaged one with another with the use of a variety of locking disks 180a, 180b, 180c, etc. FIGS. 4A through 6 illustrate an exemplary use of locking disk 180a in relation to connecting the primary takeoff 120 to the vise block 110, it being understood that several interconnections are made in the present system in a similar manner (e.g., a similar approach is used with rods 162, 140, etc.). As shown in FIG. 4A, primary rod 138 can be received within block receiving bore 118b and primary takeoff 120 can then be rotated into any degree of rotation desired, relative to the vise block 110. A block locking disk 180a can then be installed within block set screw bore 134b, after which set screw 181a can be (in this example) threaded downward until a connection is made with the locking disk. The set screw can be tightened until the force applied by the set screw to the primary rod 138 is sufficient to retain the rod in the position desired.

FIGS. 4B through 6 illustrate further details of the locking disk 180a. In one embodiment, the locking disk can include a set screw contact surface 122 and a rod contact surface 124. When installed in the set screw bore, rod contact surface can be oriented toward the rod and the set screw contact surface can be oriented toward the set screw. In one example, the rod contact surface includes an arcuate contour that matches, or mates, or nests relative to a contour of at least a portion of an outer surface of the rod. Thus, when the rod is cylindrical, the rod contact surface of the locking disk is also cylindrical. This relationship is perhaps best seen in FIG. 5B. In one embodiment, the set screw contact surface is substantially planar, to allow an end of the set screw to securely apply load across as much of the locking disk as possible.

This configuration of the block locking disk 180a enables a force applied by the block set screw 181a to the set screw contact surface 122 to be transferred through the block locking disk to the rod contact surface 124 and distribute the force evenly across the portion of the outer surface of the rod 138. This can enable an operator assembling the various components of the fixture 100 to tighten the set screw to a considerable degree, without fear of marring, gouging, scratching or otherwise damaging the rod. This can enable a very stiff assembly, even with relatively small, precisely adjustable components.

While the dimensions of the various components can vary, the set screw contact surface 122 can be dimensioned relative to the rod upon which it will nest. Thus, in one example, the rod includes a diameter “D” of about 0.624 inches and the contact surface 122 can include a curvature having a radius “R” of about 0.313 inches. In this manner, the locking disk can distribute the force applied to the rod across a large degree of the available surface area on the rod, thereby reducing the chances of gouging or marring the rod during tightening of the set screw.

The locking disks 180 can be formed of any suitable material, but in one example are formed from a metal softer than the metal from which the various rods 120, 130, 140, etc., are formed. Suitable materials include, without limitation, aluminum, brass, copper or any other metal which when compressed against the vise rod 140 is not likely to indent or deform the surface of the vise rod 140. In one example, the locking disk is cut from 5/16″ diameter aluminum rod stock. In one example, the locking disk maintains its shape when load is applied thereto with a set screw. According to other embodiments, small locking disk 190 may be formed of a hard plastic material that, if deformed at all, is elastically deformed when used in the current system.

By using embodiments of locking disks 180 as described herein, cylindrical bodies such rods 138, 162, 140, etc., of a machine tool fixture 100 may be secured in place without damaging the cylindrical surfaces of such cylindrical bodies. It will be understood that the application of such novel locking disks can extend beyond the vise stop fixture assemblies described herein. The locking disks described herein may be used in any application where a set screw is used to secure a cylindrical body within a bore hole of its support structure.

In addition to providing a secure, rigid assembly as a machine tool fixture, the present systems also provide an assembly that is nearly infinitely adjustable. As shown in FIG. 1, the locating armature (or, more precisely, the terminal portion 56 of the locating armature) can be adjusted translationally and rotatably about three axes of rotation, x, y and z, relative to the vise block 110. This can ensure that the operator can position the part to be machined in precisely the desired location within the vise.

In addition to the structural features described above, the present technology includes various methods of assembling kits for use as machine tool fixtures, methods of assembling machine tool fixtures, methods of adjusting machine tool fixtures, and methods of installing a part within a vise using a machine tool fixture.

It will be recognized that embodiments of profile systems in accordance with the invention are not limited to the above-described embodiments, and various modifications may be possible without departing from the scope of the invention as defined in the appended claims.

I claim:

1. A machine tool fixture to aid in positioning a part to be machined within a vise, the machine tool fixture comprising:
a vise block, attachable to a vise suitable for mounting on a machining table;
a primary takeoff movably couplable to the vise block;
one of the primary takeoff and the vise block having: i) a primary rod extending therefrom, ii) a block receiving bore formed therein, the primary rod being moveably receivable within the block receiving bore, and a iii) block set screw bore intersecting the block receiving bore;
a block set screw, receivable within the block set screw bore;
a block locking disk, receivable in the block set screw bore between the primary rod and the block set screw, the block locking disk having a set screw contact surface and a rod contact surface, a contour of the rod contact surface matching a contour of a portion of an outer surface of the primary rod;
the block locking disk sized and shaped to enable a force applied by the block set screw to the set screw contact surface to be transferred through the block locking disk to the rod contact surface and distribute the force evenly across the rod contact surface to the portion of the outer surface of the primary rod; and
a locating armature, carried by the machine tool fixture, the locating armature having a contact surface configured to contact a part to be machined on the machining table to properly position the part relative to the machining table.

2. The fixture of claim 1, wherein the set screw contact surface and the rod contact surface have different contours.

3. The fixture of claim 1, wherein the block set screw is threadably engageable with the block set screw bore.

4. The fixture of claim 1, wherein the block locking disk maintains its shape when under load from the block set screw.

5. The fixture of claim 1, wherein the block locking disk is formed from a softer metal than the primary rod.

6. The fixture of claim 1, wherein the contact surface of the locating armature includes a hemispherical contour.

7. The fixture of claim 1, wherein: the primary takeoff has the primary rod extending therefrom; the vise block has the block receiving bore formed therein; and the block set screw bore intersects the block receiving bore within the vise block.

8. The fixture of claim 7, further comprising:
a secondary takeoff movably coupleable to the primary takeoff, the secondary takeoff including a secondary rod movably receivable within a primary receiving bore of the primary takeoff, and a primary set screw bore is formed in the primary takeoff intersecting the primary receiving bore, and a primary locking disk is receivable in the primary set screw bore of the primary takeoff between a primary set screw and the secondary rod.

9. The fixture of claim 8, wherein the locating armature contact surface is rotatable and translatable in three axes relative to the vise block.

10. The fixture of claim 8, further comprising an armature rod moveably coupled to the secondary takeoff, the armature rod movably receiving the locating armature therein.

11. The fixture of claim 10, wherein the armature rod includes a pair of armature bores formed therein, the armature bores having differing diameters.

12. The fixture of claim 11, further comprising an armature rod cap fittable over a portion of the armature rod, the armature rod cap having a pair of cap bores formed therethrough having differing diameters, and wherein the locating armature is movably receivable through one of the cap bores and one of the armature bores.

13. A machine tool fixture to aid in positioning a part to be machined within a vise, the machine tool fixture comprising:
a vise block, attachable to a vise suitable for mounting on a machining table;
a primary takeoff movably couplable to the vise block;
the primary takeoff having a primary rod extending therefrom, the vise block having a block receiving bore formed therein, the primary rod being moveably receivable within the block receiving bore, and a block set screw bore formed in the vise block intersecting the block receiving bore;
a block set screw, receivable within the block set screw bore;
a block locking disk, receivable in the block set screw bore between the primary rod and the block set screw, the block locking disk having a set screw contact surface and a rod contact surface, a contour of the rod contact surface matching a contour of a portion of an outer surface of the primary rod;
the block locking disk sized and shaped to enable a force applied by the block set screw to the set screw contact surface to be transferred through the block locking disk to the rod contact surface and distribute the force evenly across the rod contact surface to the portion of the outer surface of the primary rod;
a secondary takeoff movably coupleable to the primary takeoff, the secondary takeoff including a secondary rod movably receivable within a primary receiving bore of the primary takeoff, and a primary set screw bore is formed in the primary takeoff intersecting the primary receiving bore, and a primary locking disk is receivable in the primary set screw bore of the primary takeoff between a primary set screw and the secondary rod; and
a locating armature, carried by the machine tool fixture, the locating armature having a contact surface configured to contact a part to be machined on the machining table to properly position the part relative to the machining table.

14. The fixture of claim 13, further comprising an armature rod moveably coupled to the secondary takeoff, the armature rod movably receiving the locating armature therein.

15. The fixture of claim 14, wherein the armature rod includes a pair of armature bores formed therein, the armature bores having differing diameters.

16. The fixture of claim 15, further comprising an armature rod cap fittable over a portion of the armature rod, the armature rod cap having a pair of cap bores formed therethrough having differing diameters, and wherein the locating armature is movably receivable through one of the cap bores and one of the armature bores.

17. The fixture of claim 13, wherein the primary rod and secondary rods are cylindrical rods and wherein the block receiving bore, primary receiving bore and secondary receiving bore are cylindrical bores.

18. The fixture of claim 13, wherein the locating armature contact surface is rotatable and translatable in three axes relative to the vise block.

19. The fixture of claim 13, wherein the respective locking disks are formed from a softer metal than the respective rods.

20. A machine tool fixture to aid in positioning a part to be machined within a vise, the machine tool fixture comprising:
a vise block, attachable to a vise suitable for mounting on a machining table;
a primary takeoff movably couplable to the vise block;
the primary takeoff having a primary rod extending therefrom, the vise block having a block receiving bore formed therein, the primary rod being moveably receivable within the block receiving bore, and a block set screw bore formed in the vise block intersecting the block receiving bore;
a block set screw, receivable within the block set screw bore;
a block locking disk, receivable in the block set screw bore between the primary rod and the block set screw, the block locking disk having a set screw contact surface and a rod contact surface, a contour of the rod contact surface matching a contour of a portion of an outer surface of the primary rod;
the block locking disk sized and shaped to enable a force applied by the block set screw to the set screw contact surface to be transferred through the block locking disk to the rod contact surface and distribute the force evenly across the rod contact surface to the portion of the outer surface of the primary rod;
a secondary takeoff movably coupleable to the primary takeoff, the secondary takeoff including a secondary rod movably receivable within a primary receiving bore of the primary takeoff, and a primary set screw bore is formed in the primary takeoff intersecting the primary receiving bore, and a primary locking disk is receivable in the primary set screw bore of the primary takeoff between a primary set screw and the secondary rod;
a locating armature, carried by the machine tool fixture, the locating armature having a contact surface configured to contact a part to be machined on the machining table to properly position the part relative to the machining table;
an armature rod moveably coupled to the secondary takeoff, the armature rod movably receiving the locating armature therein;
the armature rod including a pair of armature bores formed therein, the armature bores having differing diameters; and
an armature rod cap fittable over a portion of the armature rod, the armature rod cap having a pair of cap bores formed therethrough having differing diameters, and wherein the locating armature is movably receivable through one of the cap bores and one of the armature bores.
